(19) United States
(12) Patent Application Publication
(10) Pub. No.: US 2017/0203692 A1
(43) Pub. Date: Jul. 20, 2017

(54) METHOD AND DEVICE FOR THE DISTORTION-FREE DISPLAY OF AN AREA SURROUNDING A VEHICLE

(71) Applicant: CONTI TEMIC microelectronic GmbH, Nürnberg (DE)

(72) Inventors: Markus Friebe, Gefrees (DE); Johannes Petzold, Kulmbach (DE)

(73) Assignee: CONTINENTAL AUTOMOTIVE GMBH, Nürnberg (DE)

(21) Appl. No.: 15/309,710

(22) PCT Filed: May 6, 2015
(86) PCT No.: PCT/DE2015/200301

§ 371 Date: Feb. 22, 2017

(30) Foreign Application Priority Data
May 8, 2014 (DE) 10 2014 208 664.7

(51) Int. Cl. B60R 1/00; G06T 15/20

(52) U.S. Cl. CPC B60R 1/00; G06T 15/205; B60R 2300/00; B60R 2300/102; B60R 2300/105; B60R 2300/301; B60R 2300/303; B60R 2300/305; B60R 2300/306; B60R 2300/60; B60R 2300/607; B60R 2300/806; B60R 2300/8093

(57) ABSTRACT

A camera surround view system for a vehicle is provided. The camera surround view system includes at least one vehicle camera which supplies camera images that are processed by a data processing unit in order to generate an image of the surroundings. The image of the surroundings being displayed on a display unit, where the data processing unit re-projects textures, which are detected by the vehicle cameras, on an adaptive re-projection surface which is similar to the area surrounding the vehicle. The re-projection surface calculated based on sensor data provided by vehicle sensors.

### CROSS REFERENCE TO RELATED APPLICATION

This application claims the benefit of PCT patent application No. PCT/DE2015/200301, filed May 6, 2015, which claims the benefit of German patent application No. 10 2014 208 664.7, filed May 8, 2014, both of which are hereby incorporated by reference.

### TECHNICAL FIELD

The technical field relates generally to a method and a device for the distortion-free display of an area surrounding a vehicle, and more specifically to a road vehicle which has a camera surround view system.

### BACKGROUND

Vehicles are increasingly being equipped with driver assistance systems which assist the driver during the performance of driving maneuvers. These driver assistance systems include, in part, camera surround view systems which make it possible to display the area surrounding the vehicle to the driver of the vehicle. Such camera surround view systems include one or more vehicle cameras which supply camera images that are merged by a data processing unit of the camera surround view system to produce an image of the area surrounding the vehicle. The image of the area surrounding the vehicle is thereby displayed on a display unit. Conventional camera-based driver assistance systems project texture information from the camera system on a static projection surface, for example on a static two-dimensional base surface or on a static three-dimensional shell surface.

However, the serious disadvantage of such systems is that objects in the area surrounding the vehicle are displayed in a considerably distorted manner, since the texture re-projection surface is static and does not therefore correspond to the real surroundings of the camera system or is not similar to said surroundings. As a result, considerably distorted objects can be displayed, which form disturbing artifacts.

As such, it is desirable to present a device and a method for the distortion-free display of an area surrounding a vehicle, which prevents such distorted artefacts being shown. In addition, other desirable features and characteristics will become apparent from the subsequent summary and detailed description, and the appended claims, taken in conjunction with the accompanying drawings and this background.

### BRIEF SUMMARY

In accordance with a first exemplary aspect, a camera surround view system for a vehicle includes at least one vehicle camera which supplies camera images that are processed by a data processing unit in order to generate a surround view image or an image of the surroundings respectively, the image of the surroundings being displayed on a display unit, wherein the data processing unit re-projects textures, which are detected by the vehicle cameras, on an adaptive re-projection surface which is similar to the area surrounding the vehicle, the re-projection surface being calculated on the basis of sensor data provided by vehicle sensors.

In one possible embodiment of the camera surround view system, the sensor data provided by the vehicle sensors accurately shows the area surrounding the vehicle.

In another possible embodiment of the camera surround view system, the sensor data includes parking distance data, radar data, LIDAR data, camera data, laser scan data, and/or movement data.

In another possible embodiment of the camera surround view system, the adaptive re-projection surface includes a grid which can be dynamically modified.

In another possible embodiment of the camera surround view system, the grid of the re-projection surface can be dynamically modified as a function of the sensor data provided.

In another possible embodiment of the camera surround view system, the grid of the re-projection surface is a three-dimensional grid.

In accordance with a second exemplary aspect, a driver assistance system includes an integrated camera surround view system. The camera surround view system includes at least one vehicle camera which supplies camera images that are processed by a data processing unit in order to generate a surround view image. The surround view image may be displayed on a display unit. The data processing unit may re-project textures, which are detected by the vehicle cameras, on an adaptive re-projection surface which is similar to the area surrounding the vehicle. The re-projection surface may be calculated on the basis of sensor data provided by vehicle sensors.

A method for the distortion-free display of an area surrounding a vehicle may comprise the generating of camera images of the area surrounding a vehicle with vehicle cameras. The method may also include processing of the generated camera images in order to generate an image of the surroundings of the vehicle. The method may further include re-projecting of textures, which are detected by the vehicle cameras, on an adaptive re-projection surface which is similar to the area surrounding the vehicle, the re-projection surface being calculated on the basis of sensor data provided by vehicle sensors.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block wiring diagram in order to illustrate a camera surround view system according to one exemplary embodiment;

FIG. 2 is a flowchart illustrating a method according to one exemplary embodiment for the distortion-free display of an area surrounding a vehicle; and

FIG. 3 is a top view of a vehicle incorporating the camera surround view system according to one exemplary embodiment.

### DETAILED DESCRIPTION

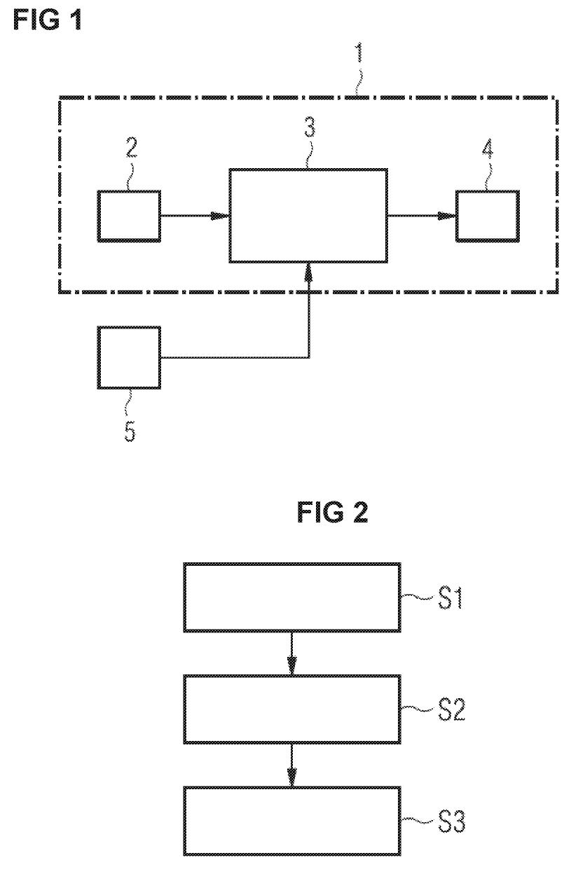

As can be seen in FIG. 1, the camera surround view system 1 in the example shown includes a plurality of components. The camera surround view system 1 includes, in the case of the embodiment example shown, at least one vehicle camera 2 which supplies camera images that are processed by a data processing unit 3 of the camera surround view system 1 to produce a surround view image or an image of the surroundings of the vehicle respectively. The surround view images or images of the area surrounding the vehicle respectively generated by the data processing unit 3 are displayed on a display unit 4. The data processing unit 3 calculates an adaptive re-projection surface on the basis of sensor data which is provided by vehicle sensors 5. Textures, which are detected by the vehicle cameras 2 of the camera surround view system 1, are re-projected on this calculated adaptive re-projection surface which is similar to the area surrounding the vehicle, as a result of which distortions or distorted artifacts respectively are minimized or eliminated respectively.

The sensors 5 shown in FIG. 1 are, for example, sensors of a parking distance control system or parking distance regulating system respectively. In addition, the sensors of the vehicle can be radar sensors or LIDAR sensors. In another possible embodiment, the sensor data is supplied by additional vehicle cameras 2, in particular a stereo camera or a mono camera, in order to calculate the adaptive re-projection surface. In another possible embodiment, the sensor data is provided by a laser scan system of the vehicle. In another possible embodiment, movement data or structure data is also used by the data processing unit 3 in order to calculate the re-projection surface. The sensor data provided by the vehicle sensors 5 reproduces the area surrounding the vehicle or objects in the area surrounding the vehicle respectively with a high degree of accuracy. These objects are, for example, other vehicles which are located in the area immediately surrounding the vehicle, for example within a radius of up to five meters. In addition, these objects can also be pedestrians who are walking past the vehicle in its immediate vicinity at a distance of up to five meters therefrom.

The re-projection surface calculated by the data processing unit 3 on the basis of the sensor data preferably includes a grid or mesh respectively, which can be dynamically modified. In one possible embodiment, this grid of the re-projection surface is dynamically modified as a function of the sensor data provided. The grid of the re-projection surface is preferably a three-dimensional grid.

The three-dimensional grid is preferably a grid-based environment model which serves to represent the vehicle environment. A grid-based environment model is based on dividing the environment of a vehicle into cells and storing one feature which describes the environment for each cell. In the case of a so-called occupancy grid, a classification into “drivable” and “occupied” is, for example, stored for each cell. In addition to drivability, a classification by means of other features can also be stored, e.g. a reflected radar energy. In addition to good compressibility, one advantage of such a grid is the high degree of abstraction, which also makes it possible to merge various sensors such as e.g. stereo camera, radar, LIDAR or ultrasound. In addition or as an alternative to the classification of the cells into “drivable” and “occupied”, a height value can also be stored as a feature for the individual grid cells, in particular for “occupied cells”, which represent obstacles or objects respectively. The height information can be stored with little additional consumption of resources and makes it possible to efficiently store and transfer the environment model. In particular, the process described above of assigning height information to the respective grid cells of an occupancy grid therefore creates a three-dimensional occupancy map of the vehicle environment, which occupancy map can be advantageously used within the framework of the present invention. The three-dimensional occupancy map can, in this case, be used as an adaptive re-projection surface on which the textures, which are detected by the vehicle cameras, are re-projected. In this case, the textures are preferably projected directly on the three-dimensional occupancy map or on the three-dimensional grid cells respectively.

The re-projection surface calculated by the data processing unit 3 is not static. Instead, it can be dynamically and adaptively adapted to the current sensor data, which is supplied by the vehicle sensors 5. In one possible embodiment, these vehicle sensors 5 can include a mono front camera or a stereo camera. In addition, the sensor units 5 can include a LIDAR system which supplies data, or a radar system which transfers radar data of the surroundings to the data processing unit 3. The data processing unit 3 can contain one or more microprocessors which process the sensor data and use this to calculate a re-projection surface in real time. Textures, which are detected by the vehicle cameras 2, are projected or re-projected respectively on this calculated re-projection surface which is similar to the area surrounding the vehicle. The display of the vehicle cameras 2 can vary. In one possible embodiment, the vehicle has four vehicle cameras 2 on four different sides of the vehicle. The vehicle is preferably a road vehicle, in particular a truck or a car. With the camera surround view system 1 according to the invention, the textures of the surroundings detected by the camera 2 of the camera system are re-projected by the adaptive re-projection surface in order to reduce or eliminate the aforementioned artefacts. Thanks to the camera surround view system 1 according to the invention, the quality of the area surrounding the vehicle shown is therefore significantly improved. Objects in the area surrounding the vehicle, for example other vehicles parked in the vicinity or persons in the vicinity, appear less distorted than is the case with systems which use a static re-projection surface.

FIG. 2 shows a flowchart in order to illustrate an embodiment of a method for the distortion-free display of an area surrounding a vehicle.

In a first step S1 camera images of the area surrounding the vehicle are generated by vehicle cameras 2. For example, the camera images are generated by multiple vehicle cameras 2 which are affixed to different sides of the vehicle.

The generated camera images are subsequently processed in step S2, in order to generate an image of the area surrounding the vehicle. In one possible embodiment, the processing of the generated camera images is carried out by a data processing unit 3 as shown in FIG. 1. The camera images are preferably processed in real time, in order to generate an appropriate image of the surroundings.

In a further step S3, a re-projection surface is initially calculated on the basis of the sensor data provided and textures, which are detected by the vehicle cameras, are subsequently re-projected on this adaptive, calculated re-projection surface. The adaptive re-projection surface includes a dynamically modifiable grid which is dynamically modified as a function of the sensor data provided. This grid is preferably a three-dimensional grid. The method shown in FIG. 2 can be implemented, in one possible embodiment, by a computer program which contains computer commands that can be executed by a microprocessor. This program is stored, in one possible embodiment, on a data carrier or in a program memory.

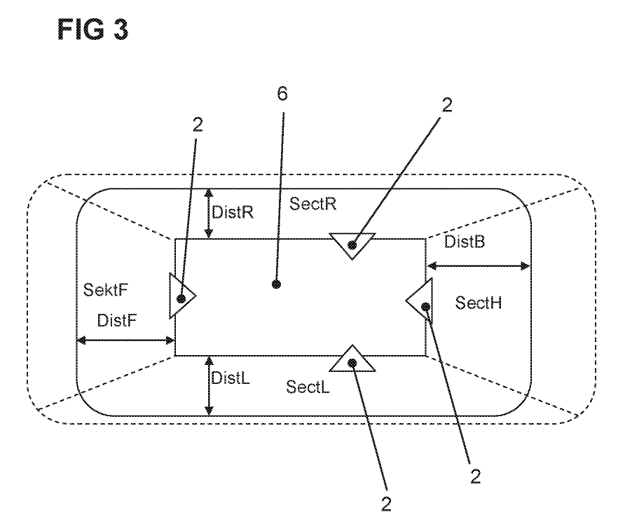

As shown in FIG. 3, the adaptive re-projection surface is a grid which can be dynamically modified. The grid thereby consists of four sectors, namely the sectors “sector on the left” (SectL), “sector on the right” (SectR), “sector at the front” (SectF) and “sector at the back” (SectB). Each of these sectors can be individually modified in the rear projection distance. To this end, there are four parameters, namely “distance on the left” (DistL), “distance on the right” (DistR), “distance at the back” (DistB) and “distance at the front” (DistF). Each sector can hereby be individually adjusted to distances of objects or obstacles respectively from the vehicle (6). One example of this is shown in FIG. 3, with a sector-wise or sector-related modification of the dynamic grid from a specified initial distance (solid line) to object distances measured by means of sensors (dashed line).

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

1. A camera surround view system for a vehicle, the camera surround view system comprising:
at least one vehicle camera which supplies camera images;
a data processing unit configured to receive and process the camera images to generate an image of surroundings; and
a display unit configured to display the image of the surroundings;
wherein the data processing unit re-projects textures detected by the vehicle cameras, on an adaptive re-projection surface which is similar to an area surrounding the vehicle, the re-projection surface calculated based on sensor data provided by vehicle sensors.

2. The camera surround view system of claim 1, wherein the sensor data provided by the vehicle sensors reproduces the area surrounding the vehicle.

3. The camera surround view system of claim 2, wherein the sensor data comprises parking distance data, radar data, LIDAR data, camera data, laser scan data and movement data.

4. The camera surround view system of claim 3, wherein the calculated adaptive re-projection surface comprises a grid which can be dynamically modified.

5. The camera surround view system of claim 4, wherein the grid of the re-projection surface can be dynamically modified as a function of the sensor data provided.

6. The camera surround view system of claim 4, wherein the grid of the re-projection surface is a three-dimensional grid.

7. The camera surround view system of claim 1, wherein the calculated adaptive re-projection surface comprises a grid which can be dynamically modified.

8. A method for a distortion-free display of an area surrounding a vehicle, the method comprising:
generating camera images of the area surrounding the vehicle by cameras of the vehicle;
processing the generated camera images to generate an image of the surroundings of the vehicle; and
re-projecting textures detected by the cameras of the vehicle, on an adaptive re-projection surface similar to the area surrounding the vehicle, the re-projection surface calculated based on sensor data provided by vehicle sensors.

9. The method of claim 8, wherein the sensor data provided by the vehicle sensors shows the area surrounding the vehicle.

10. The method of claim 9, wherein the sensor data includes parking distance data, radar data, LIDAR data, camera data, laser scan data and movement data.

11. The method of claim 8, wherein the adaptive re-projection surface comprises a grid which can be dynamically modified.

12. The method of claim 11, wherein the grid of the re-projection surface is dynamically modified as a function of the sensor data provided.

13. The method of claim 11, wherein the grid of the re-projection surface comprises a three-dimensional grid.

14. A computer program having commands, which executes a method for a distortion-free display of an area surrounding a vehicle, the method comprising:
generating camera images of the area surrounding the vehicle by cameras of the vehicle;
processing the generated camera images to generate an image of the surroundings of the vehicle; and
re-projecting textures detected by the cameras of the vehicle, on an adaptive re-projection surface similar to the area surrounding the vehicle, the re-projection surface calculated based on sensor data provided by vehicle sensors.

15. A road vehicle having a driver assistance system comprising a camera for a vehicle, the camera surround view system comprising:
at least one vehicle camera which supplies camera images;
a data processing unit configured to receive and process the camera images to generate an image of surroundings; and
a display unit configured to display the image of the surroundings;
wherein the data processing unit re-projects textures detected by the vehicle cameras, on an adaptive re-projection surface which is similar to an area surrounding the vehicle, the re-projection surface calculated bases on sensor data provided by vehicle sensors.
